(19) United States
(12) Patent Application Publication
(10) Pub. No.: US 2023/0137565 A1
(43) Pub. Date: May 4, 2023

(54) SOYBEAN CURD PRODUCTION DEVICE AND SOYBEAN CURD PRODUCTION METHOD

(71) Applicant: TAKAI TOFU & SOYMILK EQUIPMENT CO., Ishikawa (JP)

(72) Inventors: Toichiro TAKAI, Ishikawa (JP); Masahide TAKEDA, Ishikawa (JP); Taku KITAURA, Ishikawa (JP); Toshiyuki HIRASHIMA, Ishikawa (JP)

(73) Assignee: TAKAI TOFU & SOYMILK EQUIPMENT CO., Ishikawa (JP)

(21) Appl. No.: 17/906,740

(22) PCT Filed: Jul. 9, 2021
(86) PCT No.: PCT/JP2021/025947

§ 371 Date: Sep. 19, 2022

(30) Foreign Application Priority Data
Jul. 13, 2020 (JP) 2020-119817

(51) Int. Cl. A23L 11/45; B65G 15/42; B65G 19/08; A23P 30/10

(52) U.S. Cl. CPC A23L 11/45; B65G 15/42; B65G 19/08; A23P 30/10

(57) ABSTRACT

A soybean curd production device includes: a continuous coagulation machine including: an endless conveyor in which a plurality of partition blades are attached to a surface of a conveyor belt at predetermined intervals; and a coagulation tank having a recessed shape in a cross-section to allow the partition blades to pass through an inside of the coagulation tank; and a continuous forming machine including: a lower endless conveyor around which a lower fabric is wound; and an upper endless conveyor around which an upper fabric is wound. The lower endless conveyor overlaps with the coagulation tank when viewed from above such that the lower fabric is located below an outlet end portion of the coagulation tank. A bottom wall of the coagulation tank is formed substantially horizontally from a vicinity of an inlet of the coagulation tank to the outlet end portion of the coagulation tank.

### TECHNICAL FIELD

The present invention relates to a soybean curd production device including a continuous coagulation machine and a continuous forming machine, and a soybean curd production method.

### BACKGROUND ART

In the related art, various soybean curd production devices each including a boat-shaped continuous coagulation machine are known (see, for example, Patent Literatures 1 to 4).

Patent Literatures 1 and 2 disclose that a soybean curd obtained by coagulating soymilk in an automatic coagulation unit is sent to an automatic forming unit through a feed port. In particular, Patent Literature 1 discloses that a good-quality product cannot be obtained by extremely crushing soybean curd, and thick and long soybean curd is produced without crushing the soybean curd material as much as possible, and thus sending the soybean curd into the forming unit is performed by a damper with a lever that includes a balance weight at the feed port to slowly drop the soybean curd material and to uniformize an amount of the soybean curd material.

### CITATION LIST

### Patent Literature

Patent Literature 1: JP-A-551-070862
Patent Literature 2: JP-A-S51-106779
Patent Literature 3: JP-A-548-085756
Patent Literature 4: JP-A-548-085757

### SUMMARY OF INVENTION

### Technical Problem

However, in Patent Literatures 1 and 2, the automatic coagulation unit has a two-story structure disposed above an upper caterpillar of the automatic forming unit, and thus a difference in height between the automatic coagulation unit and the automatic forming unit is considerable and a considerable amount of the soybean curd is crushed. There is an effect of somewhat reducing a variation in feed amount when the soybean curd is sent in by the damper. However, the feed port is largely opened at the time of dropping of a large amount of the soybean curd and the feed port is closed at the time of dropping of a small amount of the soybean curd, and particularly, hardness of the soybean curd varies due to a change in soybean quality, and thus uniformity of quantity is poor.

The present invention has been made in view of the above problems, and an object of the present invention is to provide a soybean curd production device and a soybean curd production method capable of supplying a soymilk coagulated product from a continuous coagulation machine onto a lower fabric of a continuous forming machine without crushing the soymilk coagulated product while ensuring uniformity of quantity.

### Solution to Problem

The above object of the present invention is achieved by the following configurations.

(1) A soybean curd production device including:

a continuous coagulation machine having a boat shape, the continuous coagulation machine including:

an endless conveyor in which a plurality of partition blades are attached to a surface of a conveyor belt at predetermined intervals, and

a coagulation tank having a recessed shape in a cross-section to allow the partition blades to pass through an inside of the coagulation tank; and

a continuous forming machine including at least:
a lower endless conveyor around which a lower fabric is wound, and
an upper endless conveyor around which an upper fabric is wound, in which

the lower endless conveyor overlaps with the coagulation tank when viewed from above such that the lower fabric is located below an outlet end portion of the coagulation tank, and

a bottom wall of the coagulation tank is formed substantially horizontally from a vicinity of an inlet of the coagulation tank to the outlet end portion of the coagulation tank.

(2) The soybean curd production device according to (1), in which

the coagulation tank and the upper endless conveyor are linearly arranged side by side.

(3) The soybean curd production device according to (1) or (2), in which

the endless conveyor of the continuous coagulation machine is inclined upward in a feed direction of the continuous coagulation machine such that tip ends or attachment ends of the partition blades rise in a vicinity of an outlet of the coagulation tank.

(4) The soybean curd production device according to any one of (1) to (3), in which

the continuous coagulation machine has a supply port or a discharge port in at least one location of both side walls or the bottom wall of the coagulation tank in the vicinity of the inlet of the coagulation tank, the supply port of the discharge port being configured to allow any one of soymilk, a coagulant, and coagulant-containing soymilk or a cleaning chemical liquid to be supplied or discharged therethrough.

(5) The soybean curd production device according to (4), in which

the coagulation tank includes an opening and closing member configured to open and close the supply port.

(6) The soybean curd production device according to (5), in which

the opening and closing member is disposed so as to fill a recess formed in the side wall of the coagulation tank where the supply port is opened, and to flatly close the supply port.

(7) The soybean curd production device according to (5) or (6), in which

the partition blades are scrapers made of rubber, and

the opening and closing member is formed by the scrapers made of rubber configured to bend by contacting an inner surface of the coagulation tank to close the supply port.

(8) The soybean curd production device according to any one of (1) to (7), in which

the continuous coagulation machine is driven synchronously with the continuous forming machine.

(9) The soybean curd production device according to any one of (1) to (8), in which

a width of the coagulation tank is substantially equal to a width of a press portion of the continuous forming machine.

(10) The soybean curd production device according to any one of (1) to (9), in which

a crushing device is provided between the coagulation tank and the upper endless conveyor and above the lower fabric of the lower endless conveyor,

a protective plate with which the crushing device is allowed to come into contact is disposed at a position below the crushing device, and

the lower fabric of the lower endless conveyor is pushed downward and guided so as to avoid the protective plate.

(11) The soybean curd production device according to any one of (1) to (10), in which

the continuous coagulation machine further includes a cover that covers an upper portion of the endless conveyor.

(12) The soybean curd production device according to any one of (1) to (11), in which

in the endless conveyor, a chain connected to the conveyor belt, and a sprocket around which the chain is wound are disposed on an outside of a side wall of the coagulation tank in a width direction.

(13) A soybean curd production method for producing soybean curd by using the soybean curd production device according to any one of (1) to (12), the soybean curd production method comprising:

producing a pudding-like soymilk coagulated product using the continuous coagulation machine to coagulate and age soymilk of 50° C. to 95° C. having a solid content of 3 wt % to 20 wt % by a coagulant; and

forming the soybean curd using the continuous forming machine to convey the soymilk coagulated product by the lower fabric and press the soymilk coagulated product as necessary.

(14) The soybean curd production method according to (13), in which

the coagulant is a slow-acting coagulant or an emulsified bittern.

In the present description, the “substantially pudding-like soymilk coagulated product” refers to a state of a coagulated product after coagulation and aging, that is, a state in which water separation is 20% or less, preferably 10% or less.

### Advantageous Effects of Invention

According to the present invention, it is possible to supply a soymilk coagulated product from a continuous coagulation machine onto a lower fabric of a continuous forming machine without crushing the soymilk coagulated product while ensuring uniformity of quantity.

### BRIEF DESCRIPTION OF DRAWINGS

FIG. 1 illustrates (a) showing a schematic top view showing a soybean curd production device according to a first embodiment of the present invention, and (b) showing a schematic side view of (a).

FIG. 2 is a schematic side view showing a soybean curd production device according to a first modification of the first embodiment of the present invention.

FIG. 3 is a schematic side view showing a soybean curd production device according to a second modification of the first embodiment of the present invention.

FIG. 4 is a schematic side view showing a soybean curd production device according to a third modification of the first embodiment of the present invention.

FIG. 5 is a schematic side view showing a soybean curd production device according to a fourth modification of the first embodiment of the present invention.

FIG. 6 is a schematic side view showing a soybean curd production device according to a fifth modification of the first embodiment of the present invention.

FIG. 7 is a schematic side view showing a soybean curd production device according to a sixth modification of the first embodiment of the present invention.

FIG. 8 illustrates (a) showing a schematic side view corresponding to VIII-VIII in FIG. 1 and showing a soybean curd production device according to an example of a seventh modification of the first embodiment of the present invention, and (b) showing a schematic side view corresponding to VIII-VIII in FIG. 1 and showing a soybean curd production device according to another example of the seventh modification of the first embodiment of the present invention.

FIG. 9 illustrates (a) showing a schematic top view showing a soybean curd production device according to a second embodiment of the present invention, and (b) showing a schematic side view of (a).

FIG. 10 illustrates cross-sectional views of a vicinity of an inlet of a continuous coagulation machine in FIG. 9, in which (a) shows a state in which a supply port is closed, and (b) shows a state in which the supply port is opened.

FIG. 11 illustrates cross-sectional views of a vicinity of an inlet of a continuous coagulation machine in a soybean curd production device according to a first modification of the second embodiment of the present invention, in which (a) shows a state in which the supply port is closed, and (b) shows a state in which the supply port is opened.

FIG. 12 illustrates cross-sectional views of a vicinity of an inlet of a continuous coagulation machine in a soybean curd production device according to a second modification of the second embodiment of the present invention, in which (a) shows a state in which the supply port is closed, and (b) shows a state in which the supply port is opened.

FIG. 13 is a schematic top view of a feed portion of a coagulation tank of a continuous coagulation machine in a soybean curd production device according to a third modification of the second embodiment of the present invention.

FIG. 14 is a schematic side view of a coagulation tank of a continuous coagulation machine in a soybean curd production device according to a fourth modification of the second embodiment of the present invention.

FIG. 15 is a schematic top view of a feed portion of the coagulation tank of the continuous coagulation machine showing a process of supplying coagulant-containing soymilk to the continuous coagulation machine by using a switchable three-way valve in the soybean curd production device according to the fourth modification of the second embodiment of the present invention.

FIG. 16 illustrates (a) showing a schematic top view showing a soybean curd production device according to a third embodiment of the present invention, (b) showing a schematic side view of (a), and (c) showing an enlarged view of a portion XV in (b).

FIG. 17 illustrates (a) showing a view corresponding to the portion XV in (b) of FIG. 16 in a soybean curd production device according to a modification of the third embodiment of the present invention, and (b) showing a view corresponding to the portion XV in (b) of FIG. 16 in a soybean curd production device according to another modification of the third embodiment of the present invention.

### DESCRIPTION OF EMBODIMENTS

Hereinafter, a soybean curd production device and a soybean curd production method according to embodiments of the present invention will be described in detail with reference to the drawings.

### First Embodiment

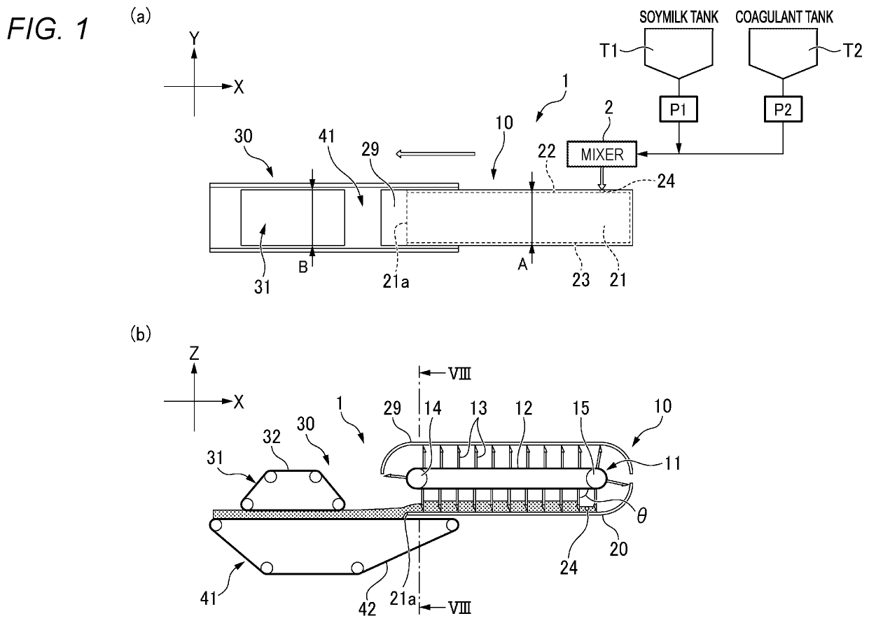

As shown in FIG. 1, a soybean curd production device 1 according to a first embodiment includes: a boat-shaped continuous coagulation machine 10 that produces a pudding-like soymilk coagulated product by coagulating and aging coagulant-containing soymilk in which soymilk and a coagulant are mixed by a mixer 2; and a continuous forming machine 30 that forms the soymilk coagulated product into soybean curd while dehydrating the soymilk coagulated product.

The soymilk and the coagulant are fed at predetermined flow rates by metering pumps P1 and P2 from a soymilk tank T1 and a coagulant tank T2 in which the soymilk and the coagulant are respectively stored, mixed by the mixer 2, and then supplied to the continuous coagulation machine 10 as the coagulant-containing soymilk. The soymilk and the coagulant may be separately and directly supplied to the continuous coagulation machine 10 and mixed in a coagulation tank 20. In any case, most of the substance (50% or more of the coagulant-containing soymilk in one compartment) is preferably supplied below a liquid level.

In the soybean curd production device 1 according to the present embodiment, the continuous coagulation machine 10 and the continuous forming machine 30 are linearly arranged side by side so that a feed direction of the coagulant-containing soymilk by the continuous coagulation machine 10 is the same as a feed direction of the soymilk coagulated product by the continuous forming machine 30. Although an installation space is wide, it is possible to transfer the soft and substantially pudding-like coagulated product uniformly without crushing the coagulated product too much. Here, a horizontal direction in which the continuous coagulation machine 10 and the continuous forming machine 30 are arranged is set as an X direction, a width direction of the continuous coagulation machine 10 and the continuous forming machine 30, which is a horizontal direction orthogonal to the X direction, is set as a Y direction, and an up-down direction of the continuous coagulation machine 10 and the continuous forming machine 30 is set as a Z direction.

The boat-shaped continuous coagulation machine 10 mainly includes: an endless conveyor 11 in which a plurality of partition blades 13 are attached to a surface of a conveyor belt (endless chain) 12 at predetermined intervals; a coagulation tank 20 formed of stainless steel and having a recessed shape in a cross-section to allow the partition blades 13 to pass through an inside of the coagulation tank 20; and a cover 29 that covers an upper portion of the endless conveyor 11.

In the endless conveyor 11, the conveyor belt (endless chain) 12 is wound around two rollers 14 and 15 arranged side by side and substantially horizontally in a vicinity of an inlet and a vicinity of an outlet of the coagulation tank 20, and the conveyor belt (endless chain) 12 and the plurality of partition blades 13 rotate due to rotation of the two rollers 14 and 15.

The conveyor belt (endless chain) 12 of the continuous coagulation machine 10 is a steel belt, or a belt, a chain, or a wire made of rigid metal such as stainless steel or titanium, and is not particularly limited as long as a large number of partition blades can be fixed.

The plurality of partition blades 13 each include a plate member 13 made of a metal steel such as stainless steel or titanium, and a member 13b made of rubber, and each have a rectangular shape that is long in the width direction and short in a longitudinal direction. The plurality of partition blades 13 are each sized to be inscribed in or be in contact with inner surfaces of a bottom wall 21 and both side walls 22 and 23 of the coagulation tank 20 by the sealing member 13b made of rubber such as flexible NBR, EPDM, (fluororubber) such as FKM, or silicon rubber so as to prevent liquids such as the soymilk and “supernatant liquid” from leaking. Therefore, in the continuous coagulation machine 10, coagulation compartments are each formed by the adjacent partition blades 13 and the coagulation tank 20.

The bottom wall 21 of the coagulation tank 20 is curved in accordance with a trajectory of tip ends of the partition blades 13 in the vicinity of the inlet through which the coagulant-containing soymilk is supplied, and is formed substantially horizontally from an outlet end portion 21a to a curved portion toward the vicinity of the inlet.

Further, at least one of the side walls 22 and 23 in the vicinity of the inlet of the coagulation tank 20 is provided with a supply port 24 through which the coagulant-containing soymilk is supplied. Therefore, the coagulant-containing soymilk supplied from the supply port 24 is coagulated and aged as the partition blades 13 move toward the vicinity of the outlet of the continuous coagulation machine 10. An opening and closing member in a second embodiment to be described later may be provided at a supply port.

Further, the cover 29 is formed in accordance with the trajectory of the tip ends of the partition blades 13 so as to cover an upper portion of the whole of the plurality of partition blades 13 located at a return portion. As a result, it is possible to prevent secondary contamination due to falling bacteria in air and to improve a heat retaining property in a coagulation and aging process during production.

The continuous forming machine 30 includes an upper endless conveyor 31 around which an upper fabric 32 is wound, and a lower endless conveyor 41 around which a lower fabric 42 is wound. A surface of the upper fabric 32 facing downward and a surface of the lower fabric 42 facing upward are substantially horizontal and face each other with a gap.

Central axes of rollers of the upper endless conveyor 31 and the lower endless conveyor 41 are arranged parallel to central axes of the two rollers 14 and 15 of the endless conveyor 11.

Further, each of the upper fabric 32 and the lower fabric 42 has flexibility and toughness, and is a resin filter fabric (see, for example, Japanese Patent No. 4004413) in which monofilaments of a fluorine resin, a polyester resin, a polypropylene resin, a polyethylene resin, or the like are woven into a plain weave, a twill weave, or the like. Each of the upper fabric 32 and the lower fabric 42 may be a wire net belt (a glasses link belt conveyor, a flat flex conveyor, a chocolate conveyor, or the like) in which a wire made of metal such as stainless steel is woven in a resin filter fabric belt and that has a flat-wound shape at starting and rear ends and forms a bottom surface and side walls on a conveyance surface, and may be a perforated or non-perforated food resin belt (a Teflon belt or a food belt).

The upper endless conveyor 31 and the lower endless conveyor 41 sandwich and press the soymilk coagulated product from upper and lower sides to form the soybean curd while dehydrating the soymilk coagulated product, and convey the soybean curd to a downstream process.

Here, the lower endless conveyor 41 overlaps with the coagulation tank 20 when viewed from above such that the lower fabric 42 is located below the outlet end portion 21a of the bottom wall 21 of the coagulation tank 20. That is, the lower endless conveyor 41 is configured to extend closer to a continuous coagulation machine side than the upper endless conveyor 31 so as to be located below and close to the coagulation tank 20.

The coagulation tank 20 and the upper endless conveyor 41 are linearly arranged side by side in the X direction above the lower fabric 42 of the lower endless conveyor 41.

Further, the continuous coagulation machine 10 is driven synchronously with the continuous forming machine 30. That is, the conveyor belt (endless chain) 12 of the endless conveyor 11 of the continuous coagulation machine 10, the upper fabric 32 of the upper endless conveyor 31 of the continuous forming machine 30, and the lower fabric 42 of the lower endless conveyor 41 are continuously driven at the same speed and in the same direction at respective feed portions.

As a result, a difference in height between the outlet end portion 21a of the bottom wall 21 of the coagulation tank 20 and the lower fabric 42 of the lower endless conveyor 41 is small, and the soymilk coagulated product can be directly transferred onto the lower fabric 42 by an inertial force of the pudding-like soymilk coagulated product conveyed out of the continuous coagulation machine 10 instead of using a dispenser or a feeder. In addition, it is possible to transfer the soymilk coagulated product onto the lower fabric 42 while ensuring uniformity of quantity by the coagulation compartments partitioned by the partition blades 13.

In a two-story structure in which a coagulation machine is disposed above a forming machine as in the related art, a soymilk coagulated product is in a state of being always crushed due to a difference in height, and at an outlet of a coagulation tank, soybean curd flows out at once for each partition section. Therefore, usually, an endless conveyor of the coagulation machine is operated intermittently and the forming machine is also operated intermittently accordingly. When the coagulation machine and the forming machine are continuously operated, the soymilk coagulated product is likely to be added non-uniformly.

On the other hand, since the soybean curd production device 1 according to the present embodiment is linear in an one-story ground arrangement, it is possible to prevent the soymilk coagulated product from flowing out at once, and it is possible to directly and softly transfer the soft and pudding-like soymilk coagulated product onto the lower fabric 42 without the difference in height and without crushing the soymilk coagulated product. When maintenance or the like of the soybean curd production device 1 is performed, work at a high place is reduced, and work safety is also improved.

For example, in a case of a hard and pudding-like soymilk coagulated product having a breaking force of 60 gf/cm² or more, a coagulation machine (Japanese Patent No. 3568193) using a steel belt can be applied, but in a case of a very soft and pudding-like soymilk coagulated product having a breaking force of less than 60 gf/cm², specifically, about 1 gf/cm² to 40 gf/cm², particularly about 5 gf/cm² to 20 gf/cm², the soymilk coagulated product slips or breaks and cannot be conveyed well. On the other hand, by using the continuous coagulation machine 10 in the present embodiment, even the very soft and pudding-like soymilk coagulated product having a small breaking force can be conveyed and transferred almost without being crushed.

Further, the continuous coagulation machine 10 and the continuous forming machine 30 are small in the difference in height and are driven at the same speed and synchronously with each other, and thus the very soft and pudding-like soymilk coagulated product can be uniformly transferred onto the lower fabric 42 of the continuous forming machine 30 without being crushed.

As compared with intermittent operation (batch type), the continuous coagulation machine 10 and the continuous forming machine 30 are small in a load exerted on a machine, are also small in a starting current value for a drive motor, and achieve energy saving. Further, as compared with batch driving, an influence of timing deviation caused by elongation or the like of a chain due to long-term use is also small.

Further, a width A of the coagulation tank 20 of the continuous coagulation machine 10 is substantially equal to a width B of a press portion (a width of the upper fabric 32 in the Y direction) of the continuous forming machine 30. Specifically, the width A of the coagulation tank 20 is 80% to 100%, preferably 90% to 100% of the width B of the press portion. In an actual size, the width B of the press portion is 500 mm to 3,000 mm (approximately 1,000 mm to 2,000 mm).

In a fried soybean curd forming machine in the related art, a coagulation state is a pasty coagulation state (a coagulation state in which a soymilk coagulated product and yellowish-green “supernatant liquid” are mixed), and a width of a coagulation tank of a boat-shaped coagulation machine is generally narrower than a forming width of a forming machine, and thus the soymilk coagulated product is spread and uniformly dispensed over the width of the forming machine by a dispenser (feeder).

On the other hand, in the present embodiment, the width A of the coagulation tank 20 of the continuous coagulation machine 10 is substantially equal to the width B of the press portion of the continuous forming machine 30, and thus the very soft and substantially pudding-like soymilk coagulated product conveyed out of the coagulation machine 10 can softly land on the lower fabric 42 of the forming machine 30 directly (without using the dispenser or the like) without being crushed when the soymilk coagulated product is transferred between the continuous coagulation machine 10 and the continuous forming machine 30.

Further, the bottom wall 21 of the coagulation tank 20 is formed substantially horizontally from the vicinity of the inlet to the outlet end portion 21a. Therefore, the difference in height is small, and it is possible to prevent deviation of a little free water (also referred to as the so-called “supernatant liquid”, “separated water”, and “exuding water”), to smoothly convey the free water together with the soft and substantially pudding-like soymilk coagulated product, and to prevent a slide-down phenomenon due to influence of gravity at the time of transferring to the forming machine.

<Modification>

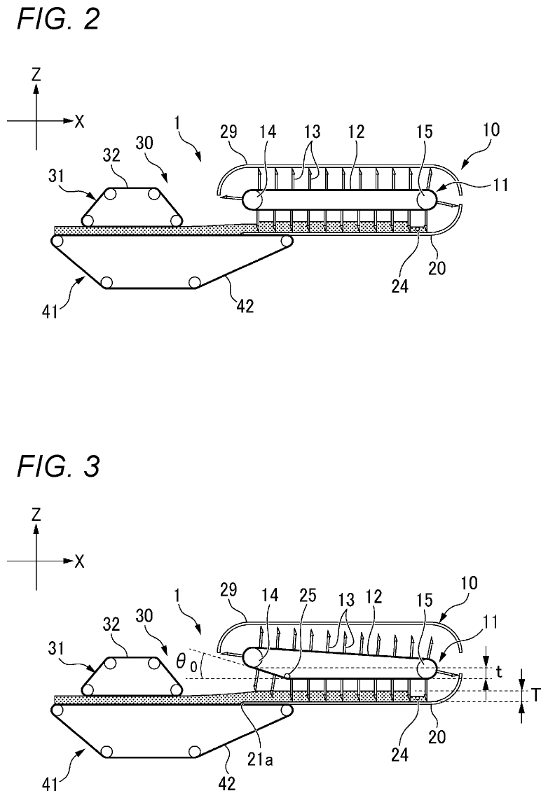

In the above embodiment, a gap is present between the bottom wall 21 of the coagulation tank 20 and the lower fabric 42, but as in a first modification shown in FIG. 2, the bottom wall 21 including the outlet end portion 21a of the coagulation tank 20 may be configured to almost come into contact with the lower fabric 42.

As a result, a difference in height between the outlet end portion 21a of the bottom wall 21 of the coagulation tank 20 and the lower fabric 42 of the lower endless conveyor 41 is smaller, and the soybean curd coagulated product can be transferred onto the lower fabric 42 more reliably without being crushed.

In the above embodiment, the endless conveyor 11 of the continuous coagulation machine 10 is configured such that the tip ends or attachment ends of the plurality of partition blades 13 move horizontally in the feed direction, but as in a second modification shown in FIG. 3, the endless conveyor 11 may be configured such that the tip ends or the attachment ends rise and move in a vicinity of an outlet of the coagulation tank 20. That is, the conveyor belt (endless chain) 12 of the endless conveyor 11 is inclined upward by an angle θ₀ (in a range of 0°≤θ₀≤30°) in a feed direction of the continuous coagulation machine 10 such that the tip ends or the attachment ends of the partition blades 13 gradually rise upward. Specifically, a height t of the roller 14 with respect to the roller 15 is preferably adjusted to be equal to or higher than a height T of the soymilk coagulated product, and the roller 14 and the roller 15 guide the conveyor belt (endless chain) 12 by turning from a feed side to a return side. Therefore, the roller 14 on an outlet side is disposed to be higher than the roller 15 on an inlet side, and after the conveyor belt (endless chain) 12 passes through a guide roller 25, the conveyor belt 12 rises together with the partition blades 13 and the partition blades 13 are gradually moved away from the lower fabric 42.

When the tip ends of the partition blades 13 move horizontally in the feed direction in the vicinity of the outlet, the partition blades 13 may kick up an upper end of the soymilk coagulated product to somewhat crush the soymilk coagulated product at the time of inverting from the feed portion to the return portion.

On the other hand, as in the modification, the partition blades 13 move upward in the vicinity of the outlet, and thus an upper end of the soymilk coagulated product is not kicked up, and the soymilk coagulated product can be reliably prevented from being crushed. Further, during coagulation and aging, separated water accumulated between the adjacent partition blades 13 (each coagulation compartment) can also be removed more quickly.

The endless conveyor 11 may be configured such that an inclination of the conveyor belt (endless chain) 12 can be adjusted as needed.

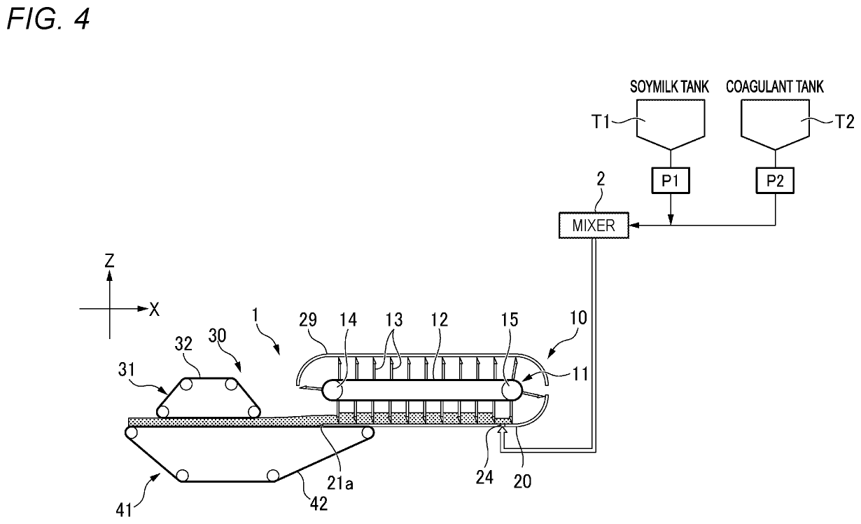

In the above embodiment, the supply port 24 through which the coagulant-containing soymilk is supplied is provided in the side wall 22 of the coagulation tank 20 in the vicinity of the inlet of the coagulation tank 20 of the continuous coagulation machine 10, but as in a third modification shown in FIG. 4, the supply port 24 may be provided in the bottom wall 21 of the coagulation tank 20.

In any of cases, it is preferable that the supply port 24 causes the coagulant-containing soymilk to flow in from below a liquid level in order to prevent foaming or bubbling. The liquid level is set assuming a case of soybean curd in which an amount of coagulant-containing soymilk supplied into a coagulation compartment is the smallest.

For example, when the soymilk and the coagulant flow in from above the inlet side of the coagulation machine 10, the supply port 24 is provided at a fixed distance so as not to interfere with the rotating partition blades 13, and thus foaming occurs or air bubbles are mixed in the coagulated product due to momentum of inflow, and the coagulation is liable to be non-uniform. Further, a space of the coagulation compartment is not stabilized, and non-uniform coagulation is also likely to occur. In particular, in the soymilk containing no defoaming agent, foaming is very likely to occur, and significant air bubbles are mixed.

On the other hand, in the above embodiment and the third modification, a shape of the space of the coagulation compartment is fixed (rectangular parallelepiped shape), and when the coagulant-containing soymilk flows in from the supply port 24, most of the coagulant-containing soymilk flows near the liquid level or in the liquid. Therefore, the homogeneous and pudding-like soymilk coagulated product with less foaming and with less air bubbles mixed is likely to be stably obtained. Since the shape of the coagulation compartment changes at a position where the partition plates turn from the return side to the feed side, when the coagulation compartment is formed which is partitioned by the front and rear partition plates after passing the turning position and is then fixed without change, a coagulation state of having high water retention property can be stably obtained by feeding the coagulant-containing soymilk.

The supply port 24 is not limited to being provided at one location of a side wall in the present embodiment and one location of a bottom wall in the third modification, and the supply ports 24 may be appropriately provided, for example, at two locations of both side walls, a plurality of locations on the bottom wall, and three locations of the both side walls and the bottom wall.

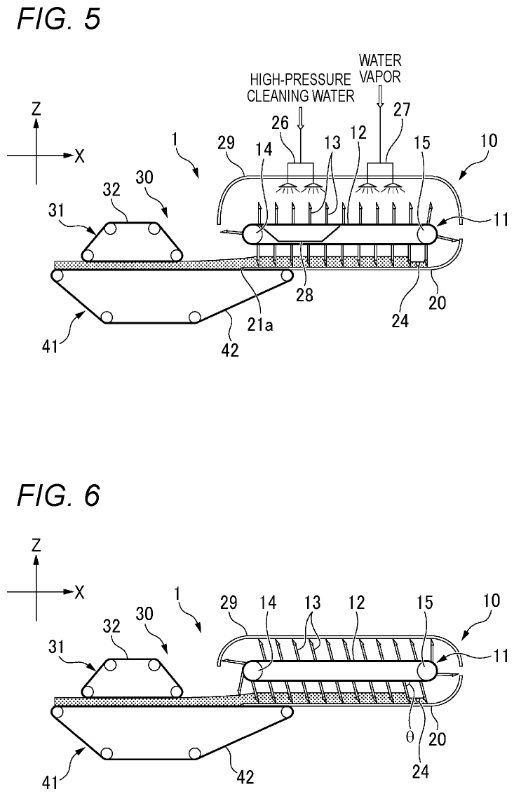

As in a fourth modification shown in FIG. 5, the continuous coagulation machine 10 may further include, on the cover 29, a cleaning unit 26 that cleans the partition blades 13 located at a return portion, and a vapor supply device 27 that supplies vapor to an inside of the cover 29. A receiving tray 28 in which a cleaning liquid is received may be provided below the cleaning unit 26 and below the partition blades 13 and the conveyor belt (endless chain) 12 located at the return portion, and in addition to during non-production, the partition blades 13 can be cleaned every time the partition blades 13 rotate one round during production, and sanitary environment can be maintained even during long-term production.

At the time of cleaning, the supply port 24 may be used as a discharge port through which the coagulant-containing soymilk or a cleaning chemical liquid is discharged, or the discharge port may be separately provided in the vicinity of the inlet of the coagulation tank 20.

The vapor is supplied to the inside of the cover 29 by the vapor supply device 27, and thus the soymilk coagulated product can be kept at a predetermined temperature. A space inside the cover 29 is maintained at 60° C. to 100° C. by using saturated vapor together with steam generated from the soymilk coagulated product, and thus it is possible to prevent propagation of various bacteria and to convey the soymilk coagulated product in a sanitary manner.

The cleaning unit 26 can perform cleaning in place (CIP) using a chemical liquid, and sterilization using vapor or hot water or a chemical liquid. Since the partition blades 13 rotate in the boat-shaped continuous coagulation machine 10, a soybean curd residue adhering to the partition blades 13 (parts each formed of stainless steel and a rubber spatula) is unsanitary after a long time elapses. Therefore, the cleaning unit 26 including a high-pressure cleaning nozzle at the return portion of the rotating trajectory of the partition blades 13 is provided to wash away the soybean curd residue during the production.

At the time of cleaning after production, immersion cleaning in which the partition blades 13 rotate is also used in combination by deeply storing the cleaning chemical liquid in the coagulation tank 20 (at a level equal to or higher than a level of the soymilk coagulated product at the time of production, and preferably in a fully filled state). Solids in the cleaning chemical liquid discharged at the outlet end portion 21a of the coagulation tank 20 are removed with a filter, and the cleaning chemical liquid is then returned to the soymilk tank or a cleaning chemical liquid tank. A waste liquid after rinsing is not returned and is drained. Further, a spray nozzle (a rotary spray nozzle, a spray ball, or the like) capable of spraying a chemical liquid may be provided in the cover 29 to perform CIP on the inside of the cover 29, the coagulation tank 20, and the partition blades 13.

Further, the coagulation tank 20 may be provided with a double structure or a heat retaining unit. The coagulation tank 20 is generally made of stainless steel, but heat dissipation is large in one sheet structure, and the quality of the soybean curd in the vicinities of the side walls and the bottom wall becomes soft. The soft soybean curd may cause a trouble with the fabric in the subsequent forming machine 30. By providing the heat retaining unit such as providing an air layer in a double structure, inserting a heat insulating material, forming a vacuum layer, and circulating and temperature-controlling hot water, water vapor or a heat medium, the aged soybean curd in both the vicinities of the side walls and the vicinity of the bottom wall is not different from the quality of the soybean curd at a central portion, elastic, soft, and pudding-like soybean curd with good sticking as a whole can be produced, and loss is also reduced. An amount of the soybean curd residue adhering to the partition blades 13 can also be reduced. Material saving is also achieved by not using the extra coagulant or cleaning water.

In the above embodiment, the partition blades 13 are attached at θ=90° relative to a horizontal conveyor belt at the feed portion, but may be attached to be inclined by a predetermined angle θ as long as the partition blades 13 are configured to be close to or come into contact with the bottom wall 21 and the side walls 22 and 23 of the coagulation tank 20.

Specifically, the partition blades 13 may be attached to the surface of the conveyor belt (endless chain) 12 at an angle in a range of 45°≤θ≤150°, preferably 60°≤θ≤90°. In particular, as in a fifth modification shown in FIG. 6, the partition blades 13 may be attached to be inclined by 45°≤θ≤90° or 60°≤θ≤90° such that the tip ends thereof are closer to the inlet than base ends in the feed portion. As a result, an upper portion of the soymilk coagulated product to be kicked up can be reduced in the vicinity of the outlet.

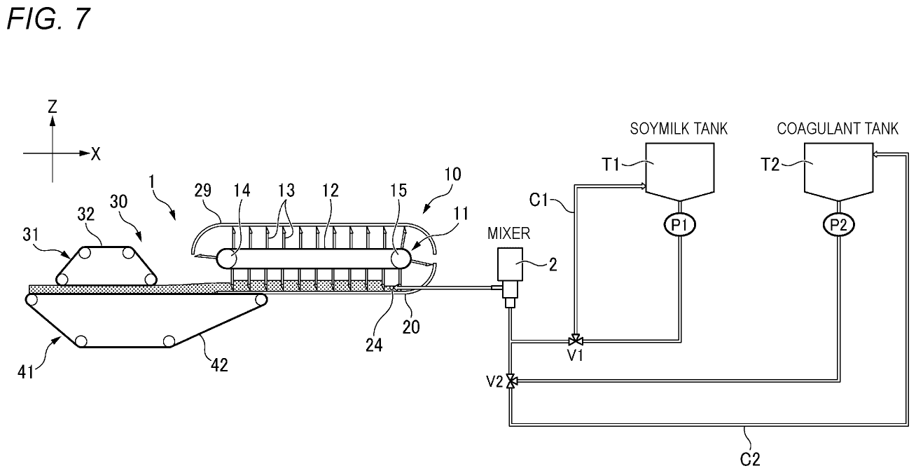

In a sixth modification shown in FIG. 7, the soymilk and the coagulant are fed at predetermined flow rates by the metering pumps P1 and P2 from the soymilk tank T1 and the coagulant tank T2, and the coagulant-containing soymilk in which the soymilk and the coagulant are mixed by the mixer 2 is then supplied to the coagulation tank 20. Valves V1 and V2 are respectively provided between the metering pump P1 and the mixer 2 and between the metering pump P2 and the mixer 2, and circulation paths C1 and C2 through which the soymilk and the coagulant are respectively returned to the soymilk tank T1 and the coagulant tank T2 are provided. In this case, the coagulant-containing soymilk may be supplied by continuous supply or batch supply.

For example, when the continuous supply of the coagulant-containing soymilk is performed, in a state where the switching valves V1 and V2 for the soymilk and the coagulant are switched to production sides, the soymilk and the coagulant always flow at the predetermined flow rates and the partition blades 13 in the coagulation tank 20 are continuously driven. In this case, batch driving of the partition blades 13 cannot be performed.

On the other hand, when the batch supply of the coagulant-containing soymilk is performed, at the time of the partition blade 13 reaching a predetermined position, the switching valves V1 and V2 for the soymilk and the coagulant are switched from circulation sides to the production sides to start supply, to the coagulation tank 20, of the coagulant-containing soymilk in which the soymilk and the coagulant are mixed by the mixer 2. When the supply of a predetermined amount is completed, the switching valves V1 and V2 are switched to the circulation sides to stop the supply. During this period, the partition blades 13 may be continuously driven, or the partition blades 13 may be driven in batch after the supply is stopped until the next partition blade 13 reaches the predetermined position. Therefore, the partition blades 13 are preferably driven by basic continuous driving, but may be driven by batch driving.

When the supply is stopped, it is preferable to perform so-called “filling standby” (see JP-A-11-346696). The filling standby is to, when the soymilk switching valve V1 and the coagulant switching valve V2 are switched from the production sides to the circulation sides, perform switching of the valve V2 more quickly and fill only the soymilk in the valve V1, then in the mixer 2, and then in the supply port 24 to stand by. As a result, the mixer 2 and the front and back of the mixer 2 can be prevented from being clogged with the soymilk coagulated product, and the soybean curd whose coagulation is crushed can be prevented from being mixed to deteriorate the quality. The soymilk component is supplied in a next batch, but no problem in quality arises when the soymilk component is mixed with the coagulant-containing soymilk. Creating a portion where the coagulant is not added in the last short time in this way and delaying a timing of the valve V1 are referred to as the “filling standby”.

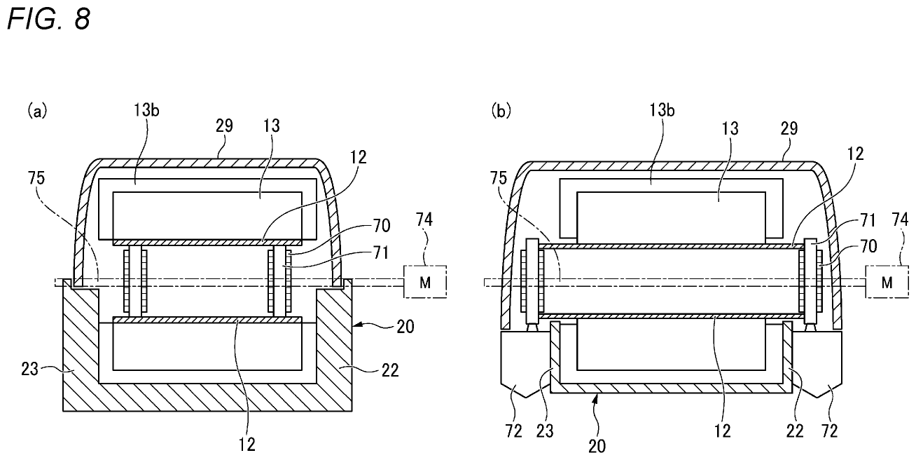

As in a seventh modification shown in (a) of FIG. 8 and (b) of FIG. 8, in the endless conveyor 11, a pair of endless chains 71 and 71 that connect the conveyor belt 12 on both sides in the width direction are wound around sprockets 70 and 70. The sprockets 70 and 70 rotate a drive shaft 75 by a drive unit 74, and thus the conveyor belt 12 is driven together with the endless chains 71 and 71. The conveyor belt 12 is implemented by a plurality of metal plates connected to the endless chains 71 and 71, and the partition blades 13 are attached to surfaces of the metal plates.

Each of the metal plates may have not only a flat plate shape but also an angle shape or a round bar shape, and an H-shaped steel, a C-shaped steel, or the like may be applied. A material of the metal plate is not limited to stainless steel, and may be titanium, aluminum, or a hard resin. The endless conveyor 11 may be configured such that the conveyor belt 12 is not provided and the partition blades 13 are directly attached to the endless chains 71. Further, a driven sprocket is disposed at a position (not shown) of the roller 15 in FIG. 1.

In an example in (a) of FIG. 8, the endless chains 71 and 71 and the sprockets 70 and 70 are disposed on insides, in the width direction, of the side walls 22 and 23 of the coagulation tank 20, whereas in an example in (b) of FIG. 8, the endless chains 71 and 71 and the sprockets 70 and 70 are disposed on outsides, in the width direction, of the side walls 22 and 23 of the coagulation tank 20.

When the endless chains 71, 71 and the sprockets 70, 70 are disposed as shown in (a) of FIG. 8, the continuous coagulation machine 10 can be designed to be compact in the width direction, and at the time of cleaning, the conveyor belt 12, the endless chains 71, 71, and the sprockets 70, 70 can be cleaned together with the partition blades 13.

When the endless chains 71, 71 and the sprockets 70, 70 are disposed as shown in (b) of FIG. 8, even if dirt such as a grease residue, an oil residue, or the soybean curd residue adhering to the chains is generated or metal powder such as rust is generated on these metal parts due to electrolytic corrosion or wear in long-term use, it is possible to prevent the dirt and the metal powder from dropping into the coagulation tank 20, a safe and sanitary embodiment with improved foreign matter entering prevention effect can be obtained, and sanitation management based on hazard analysis critical control point (HACCP: made obligatory in Japan from June 2021) can also be implemented. Further, collection tanks 72 and 72 that can separately collect the metal powder and foreign matter are provided on the outsides, in the width direction, of the side walls 22 and 23 of the coagulation tank 20, and below the endless chains 71 and 71. Therefore, during cleaning, a waste liquid containing the metal powder and a collection liquid on a product side can be distinguished from each other, and the dirt and the metal powder can be prevented from flowing into a chemical liquid pipe and a chemical liquid tank side (a pipe and a tank through which the collection liquid on the product side flows).

The endless chains 71 and 71 are not particularly limited, but it is preferable to use a chain in which foreign matter is unlikely to be generated, such as a super long life oil-free stainless steel chain. An example of the endless chains 71 and 71 includes a SUS-RB super long life stainless steel chain which is made of an RB ceramic (porous carbon material) composite material and SUS304, and even when the stainless steel chain is used in an oil-free state, wear elongation can be significantly reduced. Other examples of the endless chains 71 and 71 include a bearing roller conveyor chain having oil-free and water-resistant specifications, an environment-resistant conveyor chain, and a stainless steel conveyor chain having excellent corrosion resistance, chemical resistance, heat resistance, and cold resistance.

Further, the endless conveyor 11 may be configured to include three sets of endless chains and sprockets by connecting the endless chains to a central portion of the conveyor belt 12 in the width direction.

### Second Embodiment

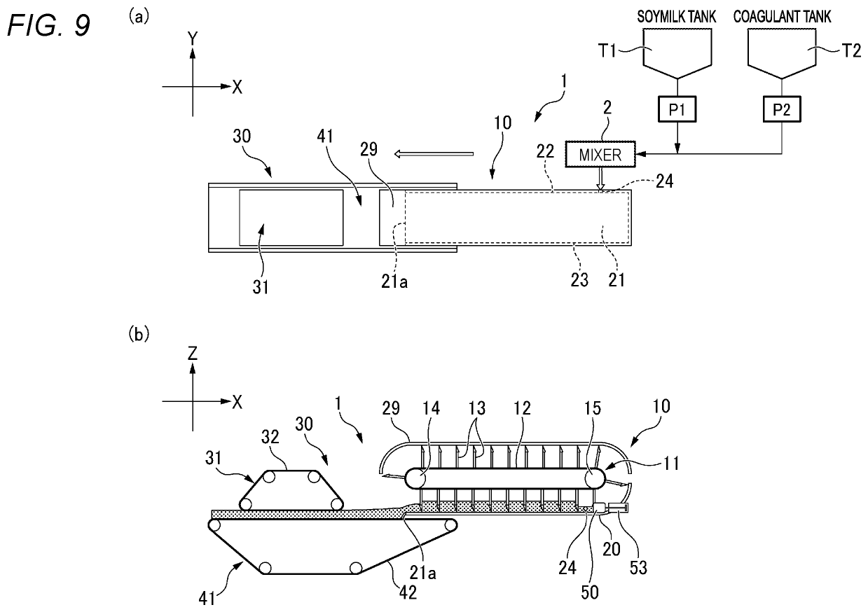

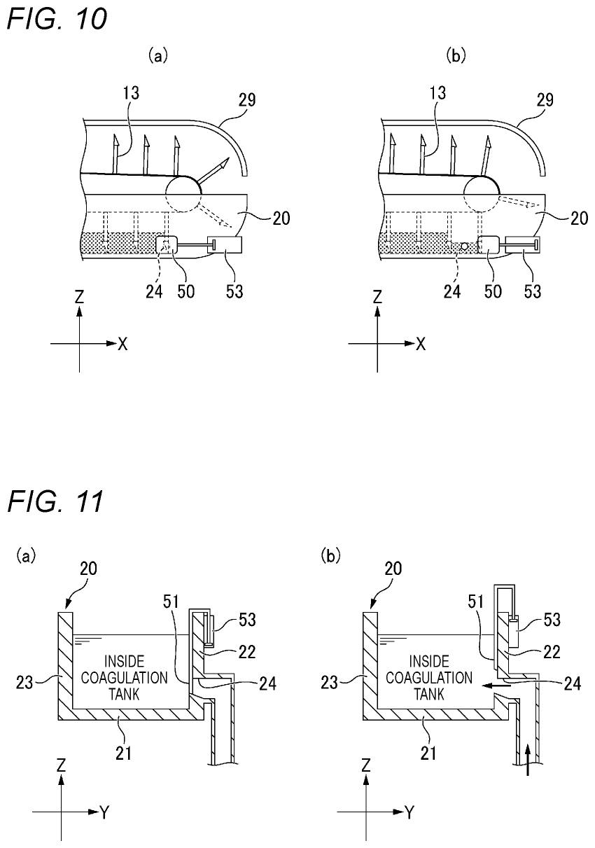

Next, a soybean curd production device according to a second embodiment of the present invention will be described with reference to FIGS. 9 and 10.

In the first embodiment described above, the continuous coagulation machine is configured to include, in the vicinity of the inlet of the coagulation tank 20, the supply port 24 through which the coagulant-containing soymilk is supplied from the side wall 22 of the coagulation tank 20, whereas in the second embodiment, the coagulation tank 20 is configured to include the opening and closing member that opens and closes the supply port 24 to prevent liquid leakage or backflow from the supply port 24.

Specifically, as shown in FIG. 10 in an enlarged manner, a shutter-type lid 50 that can be opened and closed by a cylinder 53 is provided on the side wall 22 including the supply port 24.

In this case, while the partition blade 13 is passing through the supply port 24, the shutter-type lid 50 is closed. While the partition blade 13 does not pass through the supply port 24, the rear partition blade 13 reaches a lowermost end, and the shutter-type lid 50 is then opened from a state where a sealing property is reliably ensured so that the soymilk coagulated product does not leak between the sealing member 13b and the inner surfaces of the side walls 22 and 23 and the bottom wall 21. Then, the coagulant-containing soymilk flows almost under the liquid level into the coagulation compartment of the coagulation tank 20 while measuring the coagulant-containing soymilk for a predetermined time, and the shutter-type lid 50 is closed after the predetermined measurement is completed. That is, the partition blade 13 may be driven by continuous driving or batch driving, but the coagulant-containing soymilk is supplied by batch supply. Further, the shutter-type lid 50 may be opened to supply the coagulant-containing soymilk at least until the partition blade 13 overlaps with the supply port 24 again.

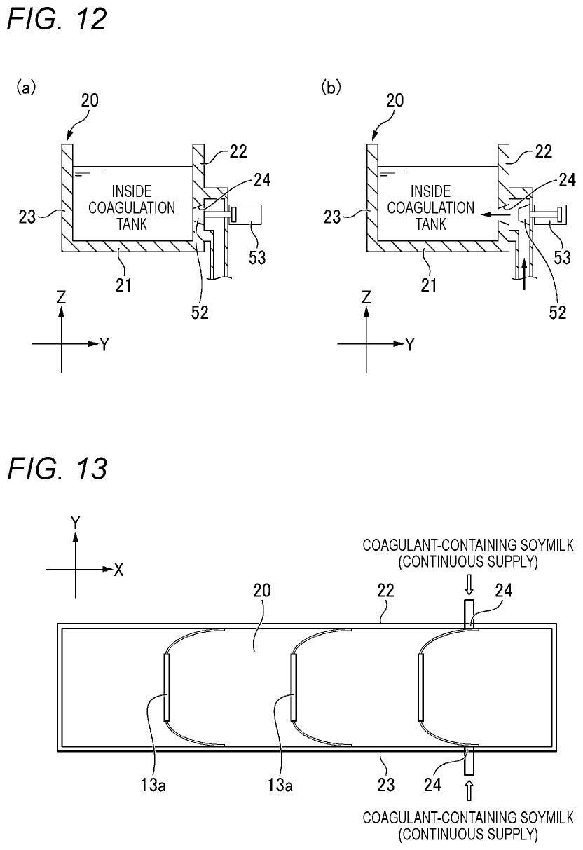

When a space portion is present in the supply port 24, a semi-mature or uncoagulated coagulant-containing soymilk coagulated product leaks backward before and after the partition blade 13 rotating continuously overlaps with the supply port 24. Therefore, as in a first modification shown in FIG. 11, it is preferable to use a shutter-type lid 51 that can be opened and closed up and down and in which no step is present between the inner surface of the side wall 22 and a lid surface in a closed state. Further, as in a second modification shown in FIG. 12, a commercially available sanitary tank valve (tank bottom valve) 52 may be used such that a tip end portion of the valve 52 closes the inner surface of the side wall 22 without a step in a closed state. That is, any opening and closing member may be used as long as the opening and closing member is a member that temporarily fills a recess (space portion) formed in the side wall of the coagulation tank 20 where the supply port 24 is opened, and flatly closes the supply port 24.

In both the first and second modifications, the coagulant-containing soymilk is intermittently supplied (batch supply) as the opening and closing member (shutter-type lid 51 and tank valve 52) is opened and closed at a timing when the partition blade 13 and the supply port 24 overlap with each other.

However, when the opening and closing member is not provided in the supply port 24 as in the above embodiment, it is preferable to provide the supply port 24 at a level equal to or higher than the liquid level of the coagulant-containing soymilk supplied to the coagulation compartment, and in this case, the coagulant-containing soymilk may be continuously supplied.

Even when the supply port 24 is below the liquid level and some leakage occurs from the recess of the supply port 24, if the liquid level is not so high and a moving speed of the partition blade 13 is not so slow (the moving speed may be instantaneously increased at the time of passing through the supply port 24.), a leakage amount is small and does not cause a problem. Thus, in this case, the opening and closing member itself may not be provided.

Further, a scraper (opening and closing member) made of rubber, which is the partition blade, may be made longer and sufficiently bent such that the scraper comes into contact with an inner surface of the coagulation tank 20 and a surface of the scraper closes the supply port 24.

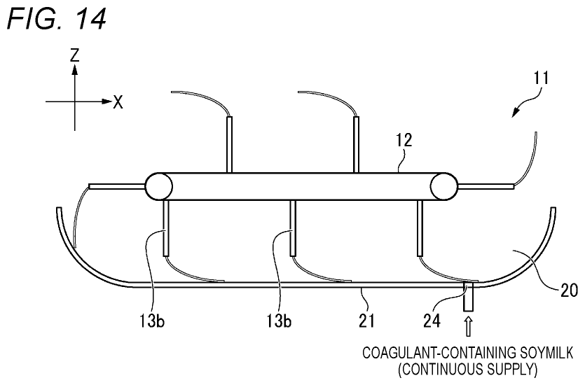

Specifically, in a third modification shown in FIG. 13, when the supply ports 24 are formed in the both side walls 22 and 23 of the coagulation tank 20, scrapers 13a made of rubber are formed to be longer in the width direction so as to temporarily close the supply ports 24 of the side walls 22 and 23. The scraper 13a made of rubber can also be applied when the supply port 24 is provided only in one side wall. In a fourth modification shown in FIG. 14, when the supply port 24 is formed in the bottom wall 21 of the coagulation tank 20, a scraper 13b made of rubber is formed to be longer in the up-down direction to temporarily close the supply port 24 of the bottom wall 21.

In both cases of the third and fourth modifications described above, the coagulant-containing soymilk may be continuously supplied.

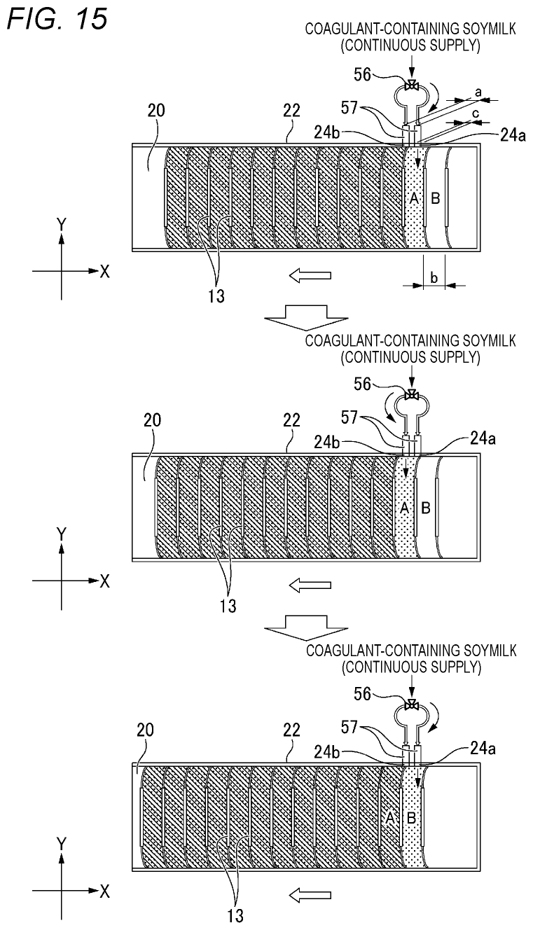

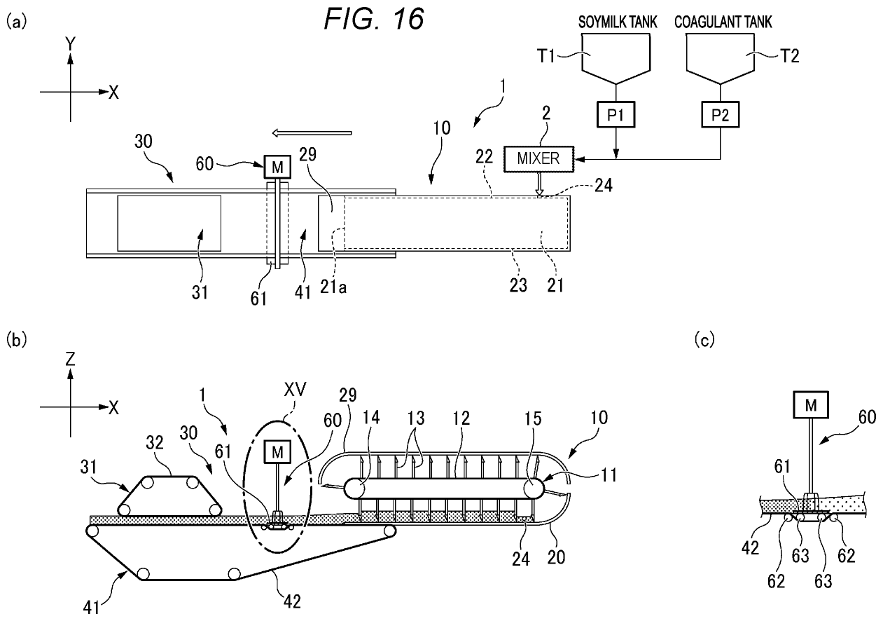

In a fifth modification shown in FIG. 15, supply ports 24a and 24b are provided in two proximity locations of one side wall 22 of the coagulation tank 20, and the coagulant-containing soymilk is continuously supplied to the continuous coagulation machine by switching the supply port using a three-way valve 56.

At a position where the partition blade 13 and the supply port 24b slightly overlap, a supply direction is changed by the three-way valve 56, supply from the supply port 24b is not performed, and supply from the supply port 24a is continued. In this case, the coagulant-containing soymilk is continuously supplied, and the partition blade 13 is also continuously driven. Therefore, unlike a batch type coagulation machine, temporary stop of the supply and filling standby are not required, the non-uniform coagulation is reduced, and the coagulation quality becomes more uniform. A horizontal distance a between centers of two nozzles 57 is preferably a size satisfying relationships of b>2c, b>a, a=b/2, and c≤a≤b−c when a pitch of the partition blades 13 is set as b and a horizontal width of an opening of the supply port 24 is set as c.

While the coagulant-containing soymilk is continuously supplied from the mixer 2, the coagulant-containing soymilk is alternately supplied to the supply ports 24a and 24b in the two locations of the coagulation tank 20. Although not shown, each supply port is provided with the opening and closing member such as a tank valve.

First, the coagulant-containing soymilk is supplied to a compartment A through a flow path on a right side, while a flow path on a left side is closed because the flow path on the left side overlaps with the partition blade 13.

Next, when the partition blade 13 advances toward the left side and overlaps with the supply port 24a on the right side, the three-way valve 56 is switched, the coagulant-containing soymilk is subsequently supplied to the compartment A through the flow path on the left side, and the supply of a predetermined amount is completed.

When the partition blade 13 further advances toward the left side and overlaps with the supply port 24b on the left side, the three-way valve 56 is switched, and the coagulant-containing soymilk is supplied to a compartment B through the flow path on the right side.

Thereafter, the coagulant-containing soymilk is continuously supplied by repeating this process. Therefore, unlike the batch type coagulation, the filling standby is not required, the non-uniform coagulation is reduced, and the coagulation quality becomes more uniform.

When the supply ports 24 are provided in three or more locations of the side wall 22 of the coagulation tank 20, switching valves may be provided according to the number of supply ports 24.

### Third Embodiment

Next, in a third embodiment, as shown in FIG. 16, a crushing device 60 is provided between the coagulation tank 20 and the upper endless conveyor 31 and above the lower fabric 42 of the lower endless conveyor 41.

Further, a protective plate 61 with which the crushing device 60 is able to come into contact is provided at a position below the protective plate 60. Therefore, the lower fabric 42 of the lower endless conveyor 41 is pushed downward and guided by using guide rollers 62 and 63 or the like, so as to avoid the protective plate 61.

As a result, a bottom of the soymilk coagulated product can be firmly crushed on an upper surface of the protective plate 61, water separation from the lower fabric 42 is promoted, and the soybean curd is well drained. Further, it is possible to obtain the soybean curd that is hard and has uniform hardness. Therefore, it is possible to solve a problem that since the soybean curd is crushed at a height of 5 mm to 10 mm above the lower fabric 42 in order to protect the lower fabric 42 in the related art, a bottom surface is hardly crushed and “two-layer soybean curd” is obtained.

The upper surface of the protective plate 61 is disposed so as to be flush with portions of the lower fabric 42 on an upstream side and a downstream side with respect to the position below the crushing device 60, and the soymilk coagulated product can be smoothly conveyed.

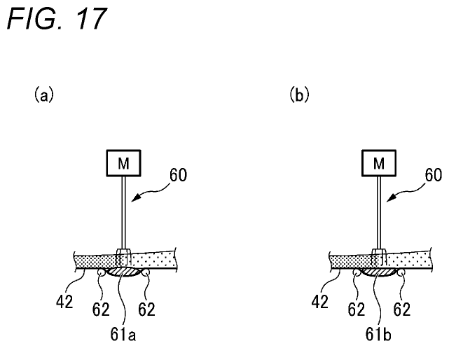

As shown in (a) of FIG. 17 and (b) of FIG. 17, the protective plate 61 with which the crushing device 60 is able to come into contact may also serve as the guide roll 63, and specifically, protective plates 61a and 61b each have a thickness such that the lower fabric 42 is not damaged, and are each chamfered with rounded corners. The protective plate 61a in (a) of FIG. 17 has an elliptical shape in which both surfaces on an upper surface side and a lower surface side are curved, and the protective plate 61b in (b) of FIG. 17 has a flat upper surface side and a curved lower surface side. The protective plate 61 may be made of rigid metal such as stainless steel, may be made of a resin, or formed of a material made of rubber and having elasticity.

Therefore, according to the present invention, silken soybean curd, soft soybean curd, firm soybean curd, fried soybean curd, thick-fried and thin-fried soybean curd, hard soybean curd, tofu pudding, or the like can be produced by using the above soybean curd production device.

Specifically, the silken soybean curd or the tofu pudding can be obtained without pressing the soft and pudding-like soymilk coagulated product. The soft soybean curd can be obtained by lightly pressing the pudding-like soymilk coagulated product and creating only grains. Further, the pudding-like soymilk coagulated product is appropriately crushed to a desired degree by the crushing device 60 and then pressed, and thus the firm soybean curd, the thick-fried and thin-fried soybean curd, the hard soybean curd, or the tofu pudding is produced. The fried soybean curd, the hard soybean curd and Okinawa style tofu are generally produced from a pasty coagulated product, but can also be produced by finely crushing the pudding-like coagulated product obtained from thin soymilk. As a result, the soybean curd that has water retention property and does not easily lose a taste thereof is obtained, a storage period becomes long by boiling sterilization or the like, and a delicious state is easily maintained.

In each soybean curd production device 1 described above, the continuous coagulation machine 10 coagulates and ages, with the coagulant, the soymilk of 50° C. to 95° C. (preferably 60° C. to 85° C.) having a solid content of 3 wt % to 20 wt %, preferably 5 wt % to 15 wt %, thereby producing the pudding-like soymilk coagulated product.

After coagulation and aging, a so-called “pasty” coagulation state in which the “supernatant liquid” and the coagulated product are separated may be obtained, and the present invention can be expected to have a great effect in a coagulation state having a pudding-shape or a silken soybean curd shape and having high water retention property.

Soft and high-quality firm soybean curd (tofu pudding shape) having high water retention property can be formed by placing the soft and pudding-like soymilk coagulated product on the lower fabric of the forming machine without crushing the soymilk coagulated product too much, and appropriately crushing the soymilk coagulated product with the crushing device 60. As a result, the method is sanitary, labor-saving, has high production efficiency, and enables mass production.

As the coagulant, a slow-acting coagulant and an emulsified bittern can be suitably used, and after mixing with soymilk, the slow-acting coagulant requires a time of 5 seconds to 180 seconds, preferably 10 seconds to 120 seconds until coagulation is started. For example, any commercially available slow-acting coagulant may be used, and in addition to an emulsified bittern in which magnesium chloride is wrapped in oil or an emulsifier, slow-acting coagulants such as GDL (glucono delta lactone), gypsum powder (calcium sulfate, coarse particle), salt, and transglutaminase can be used. A gelling auxiliary material (thickening polysaccharide) such as agar, carrageenan, curdlan, or starch may be contained. Further, a production method in which these components are appropriately blended may be used. When the emulsified bittern is used as the coagulant, sweetness can also be increased. In order to assist the slow-acting, a pH adjusting agent (sodium bicarbonate or the like) that adjusts the soymilk to alkalinity, a polyphosphate-based additive having a chelating action, or the like may be used in combination.

Although the embodiments are described above with reference to the drawings, it is needless to say that the present invention is not limited to such examples. It will be apparent to those skilled in the art that various changes and modifications may be conceived within the scope of the claims. It is also understood that the various changes and modifications belong to the technical scope of the present invention. Components in the embodiments described above may be combined freely within a range not departing from the spirit of the present invention.

The present application is based on Japanese Patent Application No. 2020-119817 filed on Jul. 13, 2020, the contents of which are incorporated herein by reference.

### REFERENCE SIGNS LIST

1: soybean curd production device
10: continuous coagulation machine
11: endless conveyor
12: conveyor belt (endless chain)
13: partition blade
20: coagulation tank
24: supply port
30: continuous forming machine
31: upper endless conveyor
32: upper fabric
41: lower endless conveyor
42: lower fabric
50, 51: shutter-type lid (opening and closing member)
52: tank valve (opening and closing member)

1. A soybean curd production device comprising:
a continuous coagulation machine having a boat shape, the continuous coagulation machine comprising:
an endless conveyor in which a plurality of partition blades are attached to a surface of a conveyor belt at predetermined intervals; and
a coagulation tank having a recessed shape in a cross-section to allow the partition blades to pass through an inside of the coagulation tank; and
a continuous forming machine comprising at least:
a lower endless conveyor around which a lower fabric is wound; and
an upper endless conveyor around which an upper fabric is wound,
wherein the lower endless conveyor overlaps with the coagulation tank when viewed from above such that the lower fabric is located below an outlet end portion of the coagulation tank, and
wherein a bottom wall of the coagulation tank is formed substantially horizontally from a vicinity of an inlet of the coagulation tank to the outlet end portion of the coagulation tank.

2. The soybean curd production device according to claim 1,
wherein the coagulation tank and the upper endless conveyor are linearly arranged side by side.

3. The soybean curd production device according to claim 1,
wherein the endless conveyor of the continuous coagulation machine is inclined upward in a feed direction of the continuous coagulation machine such that tip ends or attachment ends of the partition blades rise in a vicinity of an outlet of the coagulation tank.

4. The soybean curd production device according to claim 1,
wherein the continuous coagulation machine has a supply port or a discharge port in at least one location of both side walls or the bottom wall of the coagulation tank in the vicinity of the inlet of the coagulation tank, the supply port or the discharge port being configured to allow any one of soymilk, a coagulant, and coagulant-containing soymilk or a cleaning chemical liquid to be supplied or discharged therethrough.

5. The soybean curd production device according to claim 4,
wherein the coagulation tank comprises an opening and closing member configured to open and close the supply port.

6. The soybean curd production device according to claim 5,
wherein the opening and closing member is disposed so as to fill a recess formed in the side wall of the coagulation tank where the supply port is opened, and to flatly close the supply port.

7. The soybean curd production device according to claim 5 or 6,
wherein the partition blades are scrapers made of rubber, and
wherein the opening and closing member is formed by the scrapers made of rubber configured to bend by contacting an inner surface of the coagulation tank to close the supply port.

8. The soybean curd production device according to claim 1,
wherein the continuous coagulation machine is driven synchronously with the continuous forming machine.

9. The soybean curd production device according to claim 1,
wherein a width of the coagulation tank is substantially equal to a width of a press portion of the continuous forming machine.

10. The soybean curd production device according to claim 1,
wherein a crushing device is provided between the coagulation tank and the upper endless conveyor and above the lower fabric of the lower endless conveyor,
wherein a protective plate with which the crushing device is allowed to come into contact is disposed at a position below the crushing device, and
wherein the lower fabric of the lower endless conveyor is pushed downward and guided so as to avoid the protective plate.

11. The soybean curd production device according to claim 1,
wherein the continuous coagulation machine further comprises a cover that covers an upper portion of the endless conveyor.

12. The soybean curd production device according to claim 1,
wherein in the endless conveyor, a chain connected to the conveyor belt, and a sprocket around which the chain is wound are disposed on an outside of a side wall of the coagulation tank in a width direction.

13. A soybean curd production method for producing soybean curd by using the soybean curd production device according to claim 1, the soybean curd production method comprising:
producing a pudding-like soymilk coagulated product using the continuous coagulation machine to coagulate and age soymilk of 50° C. to 95° C. having a solid content of 3 wt % to 20 wt % by a coagulant; and
forming the soybean curd using the continuous forming machine to convey the soymilk coagulated product by the lower fabric and press the soymilk coagulated product as necessary.

14. The soybean curd production method according to claim 13,
wherein the coagulant is a slow-acting coagulant or an emulsified bittern.

15. The soybean curd production device according to claim 2,
wherein the continuous coagulation machine is configured to produce a soymilk coagulated product from coagulant-containing soymilk supplied to the coagulation tank,
wherein the continuous forming machine is configured to form the soymilk coagulated product into soybean curd while dehydrating the soymilk coagulated product,
wherein in a portion of the lower endless conveyor on a coagulation tank side, a surface of the lower fabric facing upward is disposed to be substantially horizontal, and
wherein the endless conveyor of the continuous coagulation machine is inclined upward in a feed direction of the continuous coagulation machine such that tip ends or attachment ends of the partition blades rise in a vicinity of an outlet of the coagulation tank.
